(19) United States
(12) Patent Application Publication
(10) Pub. No.: US 2025/0219551 A1
(43) Pub. Date: Jul. 3, 2025

(54) POWER CONVERSION DEVICE

(71) Applicant: TMEIC Corporation, Tokyo (JP)

(72) Inventors: Keiko TADA, Chiyoda-ku (JP); Masashi NAKAMURA, Chuo-ku (JP)

(73) Assignee: TMEIC Corporation, Tokyo (JP)

(21) Appl. No.: 18/848,713

(22) PCT Filed: Mar. 25, 2022
(86) PCT No.: PCT/JP2022/014496

§ 371 Date: Sep. 19, 2024

(51) Int. Cl. H02M 7/483; H02M 7/5395

(52) U.S. Cl. CPC H02M 7/4833; H02M 7/5395

(57) ABSTRACT

A power conversion device includes an inverter, a control circuit and a series body. The control circuit includes a modulation factor computing unit that computes a modulation factor of the inverter based on the DC voltage and an output voltage command value, a gate signal generator that generates a gate signal necessary for on/off drive of the switching elements for generation of a pulse train based on comparison between the computed modulation factor and a carrier signal, and a gate signal allocator circuit that adjusts allocation of a gate signal such that a voltage of the positive electrode side capacitor and a voltage of the negative electrode side capacitor are balanced.

### TECHNICAL FIELD

The present disclosure relates to a power conversion device and particularly to a multi-level inverter.

### BACKGROUND ART

A multi-level inverter outputs not only a zero voltage but also a voltage in at least one level on each of a positive electrode side and a negative electrode side. Pulses at each level are generally generated under pulse width modulation (PWM) control called triangular wave comparison PWM.

The multi-level inverter is configured, for example, in such a manner that a plurality of power conversion units each including an inverter circuit capable of providing outputs in three levels and an independent direct-current (DC) power supply are connected in series. Pulses at each level are outputted from individual units, and combination of pulse voltages outputted from the units is outputted from the multi-level inverter.

In this regard, in switching control of the multi-level inverter, in generation of a pulse pattern for each level to be outputted from each power conversion unit, a phase of a triangular wave to be compared with a command value is shifted for each level so that a composite pulse exhibits a staircase pattern, and furthermore, a power conversion unit to which pulses are allocated is periodically changed such that losses are not varied among power conversion units due to imbalance in switching by switching elements (see PTL 1).

Some multi-level inverters are neutral point clamped multi-level inverters. Such a multi-level inverter can output voltages in at least three levels. With variation in voltage or frequency, however, a switching time period becomes unbalanced between a positive electrode side and a negative electrode side in triangular wave comparison switching, and depending on a power factor, amounts of charging and discharging at a voltage of a positive electrode side capacitor and a voltage of a negative electrode side capacitor in a DC bus circuit become imbalanced. Voltage difference between the positive electrode side and the negative electrode side may increase, which may cause generation of overvoltage of a capacitor voltage on either the positive electrode side or the negative electrode side or increase in variation in current (torque ripple) during operation of a load.

In this connection, for example, in the case of a three-level inverter, a three-phase voltage command value to be compared with a triangular wave is appropriately corrected based on a capacitor voltage difference between the positive electrode side and the negative electrode side, a sign of a voltage command, or a current so as to change a pulse pattern after comparison with the triangular wave, to thereby prevent increase in capacitor voltage difference between the positive electrode side and the negative electrode side in the DC bus circuit during operation of the load (see PTL 2).

### CITATION LIST

### Patent Literature

PTL 1: Japanese Patent No. 4352787
PTL 2: Japanese Patent No. 6707298

### SUMMARY OF INVENTION

### Technical Problem

Switching control shown in PTL 1, on the other hand, makes switching loss uniform among power conversion units. This literature is silent about an object or an effect to keep capacitor voltages balanced between the positive electrode side and the negative electrode side in a series circuit in each unit in a multi-level or at least five-level inverter.

A method of elimination of the capacitor voltage difference between the positive electrode side and the negative electrode side of a DC bus circuit shown in PTL 2 is adapted to a neutral point clamped three-level inverter.

Since an inverter that outputs voltages in levels (at least five levels) more than three levels is different in circuit configuration, the method cannot be applied as it is.

For example, for such a multi-level inverter as including an inverter circuit capable of outputting voltages in five levels by including, for each phase, a circuit configured such that a DC bus circuit and two three-level switching circuits are connected, there are a plurality of combinations of switching for output of the same voltage, and directions of charging to and discharging from capacitors on the positive electrode side and the negative electrode side are different depending on the combinations. Therefore, a method of changing a command value based on triangular wave comparison shown in PTL 2 is unable to appropriately suppress the difference in voltage between the two capacitors.

The present disclosure was made to solve the problem above, and an object thereof is to provide a power conversion device that suppresses increase in imbalance between a voltage of a positive electrode side capacitor and a voltage of a negative electrode side capacitor in a DC bus circuit depending on variation in voltage or frequency or a power factor and to prevent occurrence of a phenomenon of overvoltage of a capacitor voltage due to increase in imbalance or a phenomenon of increase in torque ripple due to asymmetry between a positive output voltage and a negative output voltage.

### Solution to Problem

A power conversion device according to one embodiment includes an inverter including a plurality of switching elements, the inverter receiving input of a DC voltage from a DC voltage source and converting the DC voltage into a variable voltage variable frequency alternating-current (AC) voltage to output the AC voltage to a load, a control unit that controls on/off drive of the plurality of switching elements under PWM control, and a series body of a positive electrode side capacitor and a negative electrode side capacitor connected between a positive electrode and a negative electrode of the DC voltage source on an input side of the inverter. An output potential of the inverter at least has a potential of the positive electrode and a potential of the negative electrode of the DC voltage source and a potential of a neutral point which is a point of connection between the positive electrode side capacitor and the negative electrode side capacitor. The control unit includes a modulation factor computing unit that computes a modulation factor of the inverter based on the DC voltage and an output voltage command value, a gate signal generator that generates a gate signal necessary for on/off drive of the switching elements for generation of a pulse train based on comparison between the computed modulation factor and a carrier signal, and a gate signal allocator that adjusts allocation of the gate signal such that a voltage of the positive electrode side capacitor and a voltage of the negative electrode side capacitor are balanced.

### Advantageous Effects of Invention

A power conversion device according to the present disclosure can suppress increase in imbalance between a voltage of a positive electrode side capacitor and a voltage of a negative electrode side capacitor in a DC bus circuit depending on variation in voltage or frequency or a power factor and prevent occurrence of a phenomenon of overvoltage of a capacitor voltage due to increase in imbalance or a phenomenon of increase in torque ripple due to asymmetry between a positive output voltage and a negative output voltage.

### BRIEF DESCRIPTION OF DRAWINGS

FIG. 1 is a circuit diagram showing an overall configuration of a power conversion device 2 based on a first embodiment.

FIG. 2 is a diagram showing a hardware configuration of power conversion device 2 based on the first embodiment.

FIG. 3 is a diagram illustrating a configuration of a portion corresponding to a single phase (U phase) of an inverter 4 based on the first embodiment.

FIG. 4 is a diagram illustrating relation between switching legs 8a and 8b and a level of an output voltage from a single-phase circuit of inverter 4 based on the first embodiment.

FIG. 5 is a diagram illustrating an operation of a carrier comparison PWM generator 12 as a comparative example.

FIG. 6 is a diagram illustrating a value of a neutral point current Ic and increase and decrease in capacitor voltage difference V_{diff} on a positive electrode side in each pattern.

FIG. 7 is a diagram illustrating gate pulse signals GA # and GB # based on the first embodiment.

FIG. 8 is a circuit diagram showing an overall configuration of a power conversion device 2 # based on a second embodiment.

FIG. 9 is a diagram illustrating an operation of a neutral point potential switching control unit 15 based on the second embodiment.

FIG. 10 is a flowchart illustrating the operation of neutral point potential switching control unit 15 according to the second embodiment.

### DESCRIPTION OF EMBODIMENTS

An embodiment will be described below with reference to the drawings. In the description below, the same elements have the same reference characters allotted. Since their labels and functions are also the same, detailed description thereof will not be repeated.

### First Embodiment

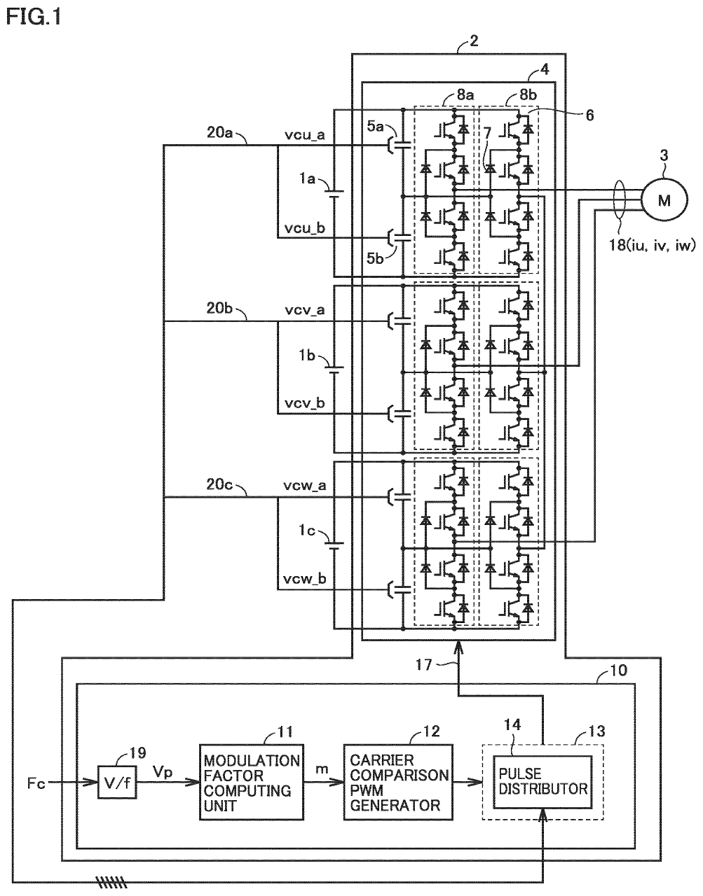

FIG. 1 is a circuit diagram showing an overall configuration of a power conversion device 2 based on a first embodiment. Referring to FIG. 1, power conversion device 2 includes an inverter 4 and a control unit 10 that controls inverter 4, and converts DC voltages from DC voltage sources 1a, 1b, and 1c of U, V, and W phases into variable voltage variable frequency AC voltages to output the AC voltages to a motor 3 which is a load.

Inverter 4 implements a five-level inverter in which two switching legs 8a and 8b each forming a neutral point clamped three-level inverter are connected in parallel for each phase. The neutral point clamped three-level inverter includes two series-connected capacitors which are a positive electrode side capacitor 5a and a negative electrode side capacitor 5b that divide a DC voltage from DC voltage source 1a, a plurality of switching elements 6 implemented by IGBTs or the like having respective diodes connected in anti-parallel, and a clamp diode 7.

As described above, a switching pattern or the like in connection with a configuration of the five-level inverter in which two switching legs 8a and 8b each forming the three-level inverter are connected in parallel for each phase will be described below. In consideration of an application of the present disclosure, however, limitation to the five-level inverter is not intended, and a configuration for output of voltages in at least nine levels in which inverter circuits are further connected in series in a plurality of stages for each phase is also similarly applicable.

Inverter 4 converts DC voltages from DC voltage sources 1a to 1c into AC voltages of any magnitude and frequency by on/off drive of switching elements 6 under the pulse width modulation (PWM) control to output the AC voltages. Inverter 4 further includes, in a portion of connection to motor 3, a current sensor 18 as a load current detector that detects a current of motor 3 which is load currents iu, iv, and iw and neutral point voltage sensors 20a, 20b, and 20c that detect as a neutral point voltage, a difference in voltage between positive electrode side capacitor 5a and negative electrode side capacitor 5b that divide voltages of DC voltage sources 1a to 1c of inverter 4.

Control unit 10 is composed of a V/f controller 19, a modulation factor computing unit 11, a carrier comparison PWM generator 12, and a gate signal allocator 13, and gate signal allocator 13 includes a pulse distributor 14.

Each of these components will be described below.

V/f controller 19 is a controller that outputs a voltage command value Vp by multiplying an inputted frequency command Fc by a prescribed coefficient. A coefficient calculated by dividing a rated voltage of the motor by a rated frequency is generally used as this coefficient.

Modulation factor computing unit 11 computes a modulation factor command m in accordance with an expression (1) based on a DC voltage Vdc from DC voltage sources 1a to 1c and an output voltage command value (corresponding to a line voltage) Vp of inverter 4 and outputs the modulation factor command.

$$\begin{matrix}[ Expression 1 ] & \\ m = \sqrt{\frac{2}{3}} * \frac{Vp}{Vdc} & ( 1 )\end{matrix}$$

Carrier comparison PWM generator 12 compares modulation factor command m outputted from modulation factor computing unit 11 with a triangular wave (a carrier signal below) in prescribed frequency cycles and generates and outputs two sets of three-level gate pulse signals outputted from two switching legs.

Pulse distributor 14 of gate signal allocator 13 determines to switching elements in which of two switching legs 8a and 8b the two sets of generated gate pulse signals are to be allocated, and in accordance with the determination, pulse distributor 14 outputs a gate pulse signal 17 to the switching elements in each of switching legs 8a and 8b.

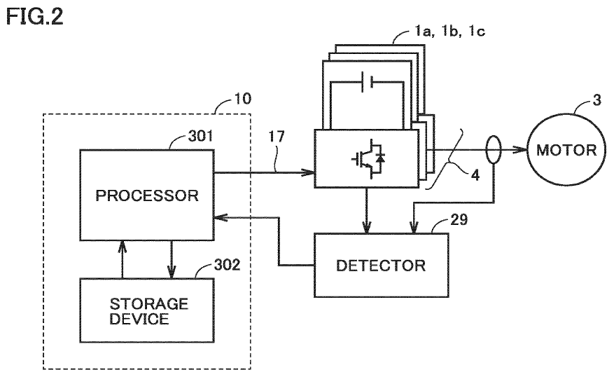

FIG. 2 is a diagram showing a hardware configuration of power conversion device 2 based on the first embodiment. Referring to FIG. 2, inverter 4 converts DC voltages from DC voltage sources 1a, 1b, and 1c of U, V, and W phases into variable voltage variable frequency AC voltages to output the AC voltages to motor 3 which is the load.

Control unit 10 includes a processor 301 and a storage device 302. A program for control unit 10 is stored in advance in storage device 302. Processor 301 executes a functional program stored in storage device 302. Various functions are performed by execution of the functional program by processor 301.

Control unit 10 includes V/f controller 19, modulation factor computing unit 11, carrier comparison PWM generator 12, and gate signal allocator 13. Gate signal allocator 13 includes pulse distributor 14.

A detector 29 is composed of a sensor group that detects a voltage and a current of each component of inverter 4. In the present example, by way of example, detector 29 includes current sensor 18 and neutral point voltage sensors 20a to 20c.

Processor 301 generates gate pulse signal 17 that drives switching elements 6 in inverter 4 to turn on and off the same by computing processing based on information from detector 29.

Operations will now be described.

Operations of inverter 4 based on on/off drive of switching elements 6 in two switching legs 8a and 8b will be described.

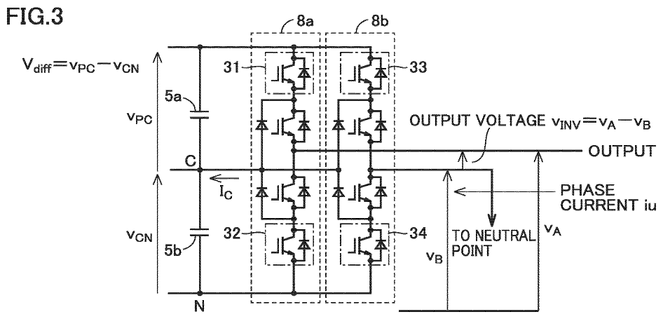

FIG. 3 is a diagram illustrating a configuration of a portion corresponding to a single phase (U phase) of inverter 4 based on the first embodiment. Referring to FIG. 3, three-level output voltages V_{A} and V_{B} are outputted from respective switching legs 8a and 8b. Switching leg 8a is connected to a phase output terminal of the inverter and switching leg 8b is connected to a neutral point of three phases. Therefore, relation among an output voltage V_{INV} of a single-phase inverter, output voltage V_{A} from switching leg 8a, and output voltage V_{B} from switching leg 8b is shown in an expression (2) below.

$$\begin{matrix}[ Expression 2 ] & \\ {V}_{INV} = {V}_{A} - {V}_{B} & ( 2 )\end{matrix}$$

A capacitor voltage difference V_{diff} is shown in an expression (3) below, where V_{PC} represents a voltage of positive electrode side capacitor 5a in a DC bus circuit and V_{CN} represents a voltage of negative electrode side capacitor 5b in the DC bus circuit.

$$\begin{matrix}[ Expression 3 ] & \\ {V}_{diff} = {V}_{PC} - {V}_{CN} & ( 3 )\end{matrix}$$

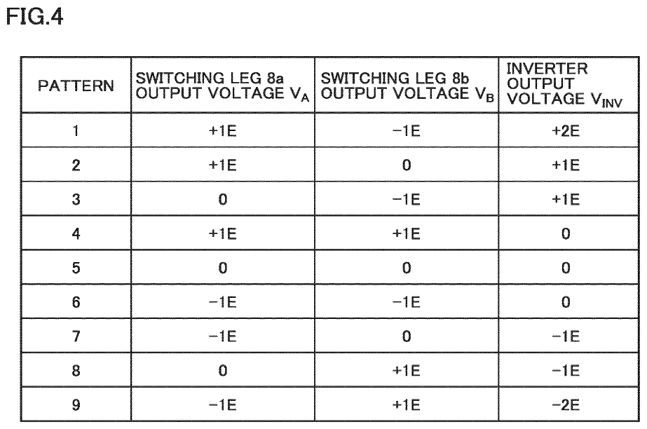

FIG. 4 is a diagram illustrating relation between switching legs 8a and 8b and a level of an output voltage from a single-phase circuit of inverter 4 based on the first embodiment.

Referring to FIG. 4, “E” shown for an output voltage represents a unit of voltage per one level outputted from the multi-level inverter.

An output level of output voltage V_{A} from switching leg 8a is reflected on output from inverter 4 as it is, whereas the output level of output voltage V_{B} from switching leg 8b is reflected with positive and negative being reversed.

For example, in output of a voltage of +1E from inverter 4 through switching leg 8b, switching elements 31 and 32 on a positive electrode side and a negative electrode side of switching leg 8a are turned off to set output voltage V_{A} to 0, and switching element 33 on the positive electrode side of switching leg 8b is turned off and switching element 34 on the negative electrode side is turned on to output −1E as output voltage V_{B}.

How the gate pulse signal is allocated will now be described.

Carrier comparison PWM generator 12 generates two sets of three-level gate pulse signals.

Gate signal allocator 13, with pulse distributor 14, allocates gate pulse signal 17 to one of two switching legs 8a and 8b and outputs the gate pulse signal.

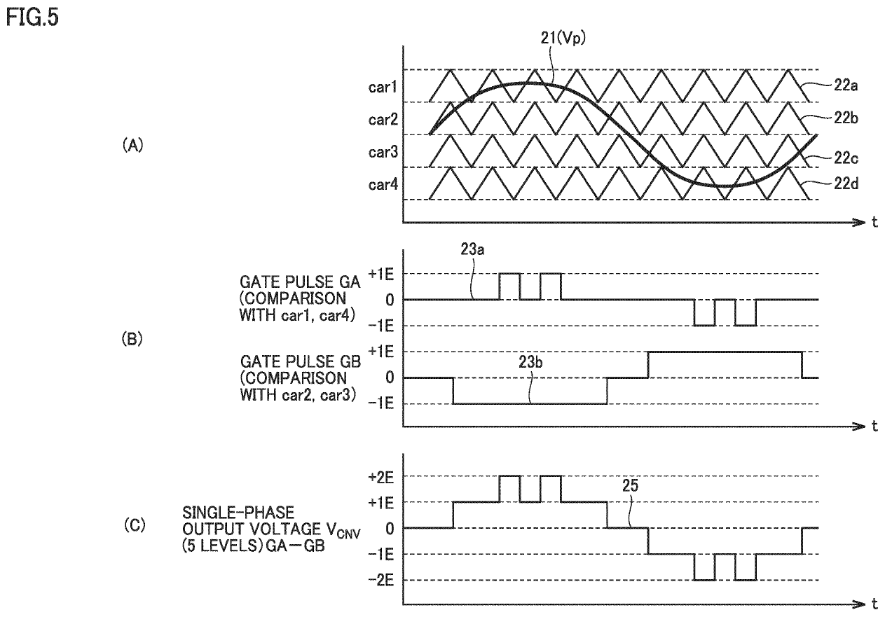

FIG. 5 is a diagram illustrating an operation of carrier comparison PWM generator 12 as a comparative example. Referring to FIG. 5 (A), a waveform 21 represents modulation factor command value Vp and shows variation in electrical degree in one cycle.

The present example shows four carrier signals car1 to car4 (waveforms 22a to 22d). Carrier signals car1 and car2 are carrier signals for generation of pulsed signals on the positive electrode side of two three-level pulses. Carrier signals car3 and car4 are carrier signals for generation of pulsed signals on the negative electrode side of two three-level pulses.

Referring to FIG. 5 (B), a three-level pulsed signal generated based on comparison with carrier signal car1 and carrier signal car4 in response to modulation factor command value Vp in one cycle is a gate pulse signal GA (a waveform 23a).

A three-level pulsed signal generated based on comparison with carrier signal car2 and carrier signal car3 in response to modulation factor command value Vp in one cycle is a gate pulse signal GB (a waveform 23b).

Gate pulse signal GA is outputted to switching leg 8a. Gate pulse signal GB is outputted to switching leg 8b.

Referring to FIG. 5 (C), a single-phase output voltage Vcnv is expressed as a difference (a waveform 25) between gate pulse signal GA and gate pulse signal GB.

In this case, a frequency of switching of switching leg 8b is higher than a frequency of switching of switching leg 8a, and switching leg 8b is longer in on time period.

Referring to FIG. 5 (B), based on comparison of the gate pulse signal for switching leg 8a with the gate pulse signal for switching leg 8b, a section where switching leg 8a provides 0 and switching leg 8b provides +1E or −1E is longer than other sections.

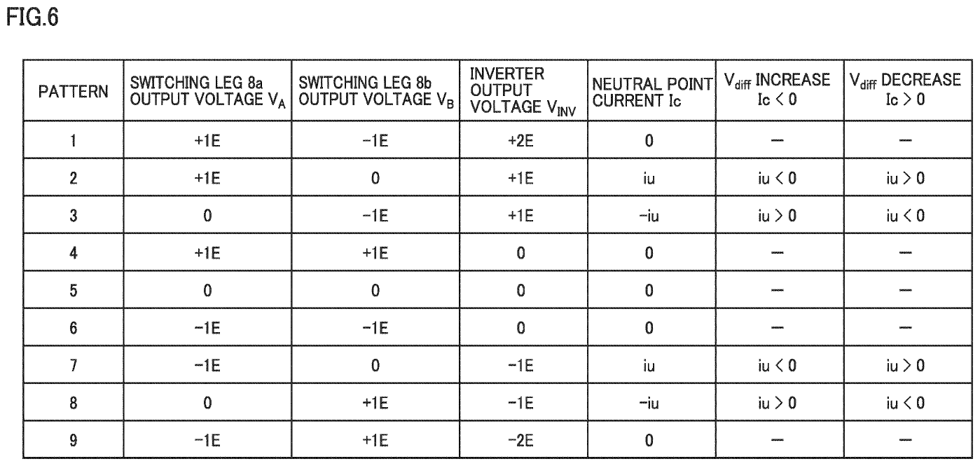

FIG. 6 is a diagram illustrating a value of a neutral point current Ic and increase and decrease in capacitor voltage difference V_{diff} on the positive electrode side in each pattern.

Referring to FIGS. 5 and 6, neutral point current Ic flows in a section where switching leg 8a provides 0 and switching leg 8b provides +1E or −1E or a section where switching leg 8b provides 0 and switching leg 8a provides +1E or −1E.

In this case, while the output voltages from switching leg 8a and switching leg 8b fall under such combination, neutral point current Ic for charging to and discharging from capacitor 5b is −iu (positive and negative of phase current iu being reverse).

When a load is great and phase current iu is great, capacitor voltage difference V_{diff} greatly repeats increase and decrease in units of ½ cycle.

Furthermore, in the case of asynchronous PWM, carriers that generate pulses are not in synchronization with a frequency of the electrical degree. Therefore, an amount of the neutral point current that flows in and out of capacitor 5b every one cycle of the electrical degree tends to be asymmetric between the positive electrode side and the negative electrode side, and consequently, the difference between two capacitor voltages of the DC bus circuit tends to become large.

In order to solve this problem, switching should be made such that an amount of charging to and discharging from the capacitor is smaller, by changing an orientation of neutral point current Ic a plurality of times in ½ cycle of the electrical degree.

In the first embodiment, gate signal allocator 13 adjusts allocation of the gate signal such that the voltage of the positive electrode side capacitor and the voltage of the negative electrode side capacitor are balanced. Specifically, in switching for output of two three-level gate pulse signals GA and GB based on comparison of carriers, pulse distributor 14 of gate signal allocator 13 makes adjustment such that switching leg 8a and switching leg 8b where the switching elements are turned on alternate.

Specifically, adjustment is made such that a section where the neutral point current flows, that is, a section where output from one switching leg is 0 and output from the other switching leg is either +1E or −1E, is made shorter and a positive or negative direction frequently changes.

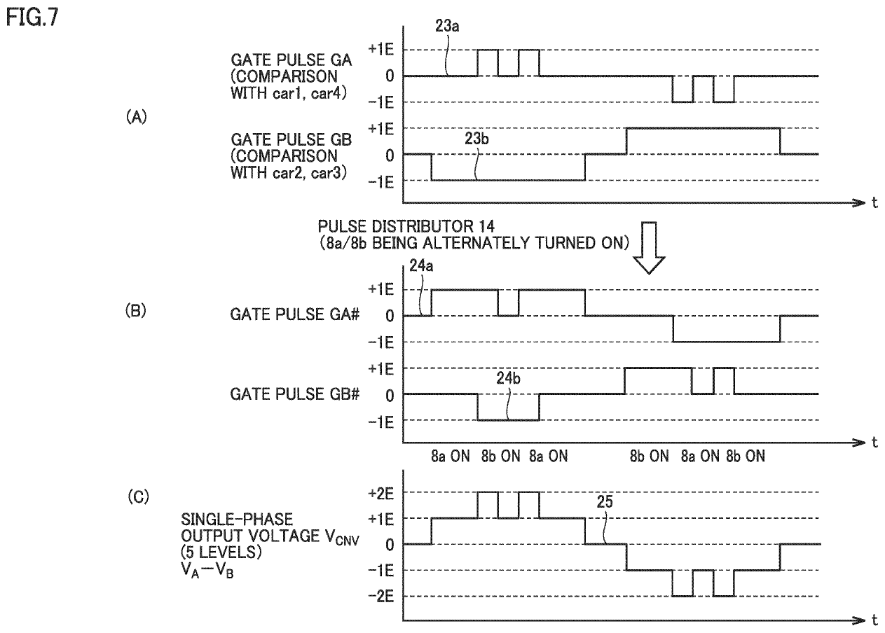

FIG. 7 is a diagram illustrating gate pulse signals GA # and GB # based on the first embodiment. Referring to FIG. 7 (A), gate pulse signal GA is a three-level pulsed signal GA (waveform 23a) generated based on comparison with carrier signal car1 and carrier signal car4 in response to modulation factor command value Vp. Gate pulse signal GB is a three-level pulsed signal GB (waveform 23b) generated based on comparison with carrier signal car2 and carrier signal car3 in response to modulation factor command value Vp.

Referring to FIG. 7 (B), adjustment to gate pulse signals GA # (a waveform 24a) and GB # (a waveform 24b) is made such that time of on of a switching pulse in switching leg 8a and time of on of a switching pulse in switching leg 8b alternate.

Referring to FIG. 7 (C), single-phase output voltage Vcnv is represented as a difference (waveform 25) between gate pulse signal GA and gate pulse signal GB.

Switching leg 8a and switching leg 8b are alternately turned on, the section where any one of two switching legs 8a and 8b provides 0 and the other provides +1E or −1E becomes shorter, and an orientation of the current that flows through the neutral point in that section changes from time to time. Therefore, an amount of current charged to the capacitor and discharged from the capacitor decreases and variation in difference in capacitor voltage can also be less.

Furthermore, capacitor voltage difference V_{diff} is calculated in accordance with the expression (3), based on two capacitor voltages V_{PC} and V_{CN} of the DC bus circuit of each phase obtained from neutral point voltage sensors 20a to 20c.

When an absolute value exceeds a threshold value, information on a switching leg that will be turned on next is once reset.

Until capacitor voltage difference V_{diff} becomes smaller than the threshold value, switching to switching leg 8a→switching leg 8b→switching leg 8a that is turned on first every one cycle of frequency command Fc is made.

For example, when the absolute value of voltage difference V_{diff} between two capacitors 5a and 5b in the DC bus circuit obtained by neutral point voltage sensor 20a in the U-phase circuit exceeds the threshold value, with the section (=corresponding to one cycle of frequency command Fe) from a time point when the phase of a next inverter output voltage becomes 0 degree until the phase attains to 360° being defined as fnumber=1, switching leg 8a is allocated as the switching leg that is turned on first in that section. Then, in a next cycle fnumber=2, such switching that switching leg 8b is allocated as the switching leg that is turned on first is made. Accumulation of imbalance between the positive and the negative of the neutral point current that flows at the time of switching can be eliminated, and increase in capacitor voltage difference V_{diff} can further be prevented.

As described above, the pulse distributor that allocates the gate signals to the switching elements in switching leg 8a and switching leg 8b such that the switching elements in switching leg 8a and the switching elements in switching leg 8b are alternately turned on to provide the voltage of +1E or −1E while inverter 4 outputs the same voltage can suppress increase in imbalance between two capacitors 5a and 5b in the DC bus circuit also during operation of the load and prevent overvoltage trip (abnormal stop) of the capacitor voltage.

### Second Embodiment

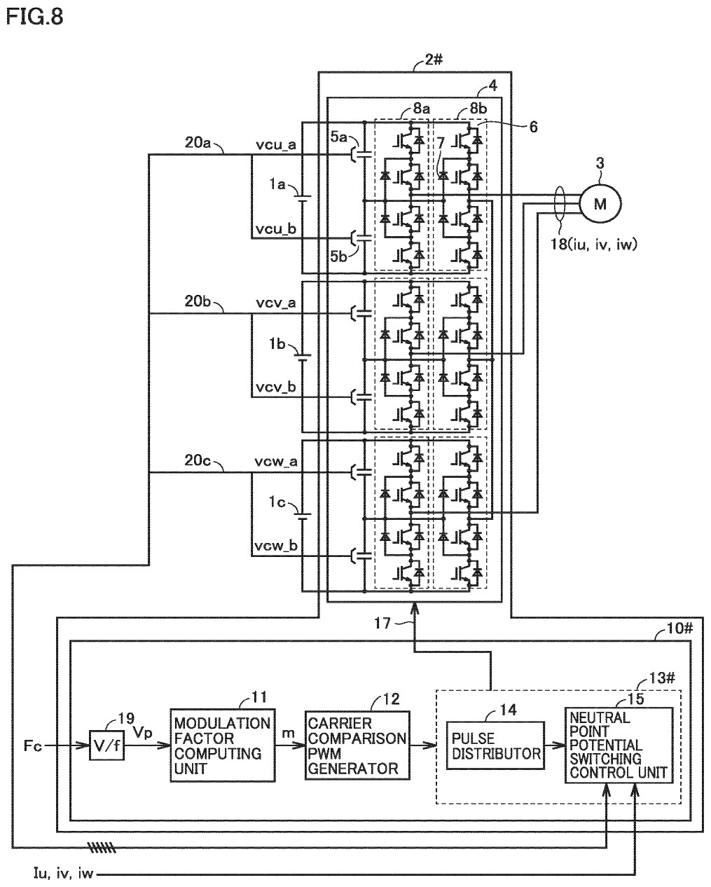

FIG. 8 is a circuit diagram showing an overall configuration of a power conversion device 2 # based on a second embodiment. Referring to FIG. 8, power conversion device 2 # is different from power conversion device 2 described with reference to FIG. 1 in replacement of control unit 10 with a control unit 10 #. Control unit 10 # is different from control unit 10 in replacement of gate signal allocator 13 with a gate signal allocator 13 #. Gate signal allocator 13 # includes pulse distributor 14 and a neutral point potential switching control unit 15 as compared with gate signal allocator 13. Since the configuration is otherwise the same as described with reference to FIG. 1, detailed description thereof will not be repeated.

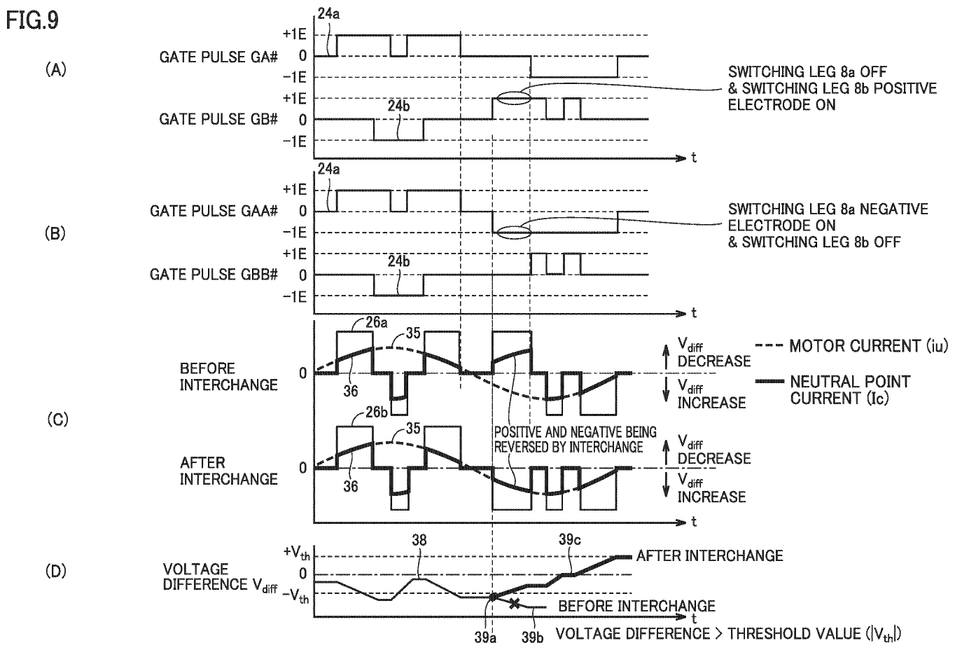

FIG. 9 is a diagram illustrating an operation of neutral point potential switching control unit 15 based on the second embodiment.

FIG. 9 (A) is similar to FIG. 7 (B), and adjustment to gate pulse signals GA # (waveform 24a) and GB # (waveform 24b) is made such that time of on of a switching pulse in switching leg 8a and time of on of a switching pulse in switching leg 8b alternate owing to pulse distributor 14.

FIG. 9 (C) shows a pulse (26a) which is extraction only of a section where any one of gate pulse signal GA # (24a) and gate pulse signal GB # (24b) is 0 and the other is +1E or −1E.

At this time, a waveform 36 representing the neutral point current is the same as a motor current 35 of the U phase while only switching leg 8a is on (+1E or −1E). While only switching leg 8b is on (+1E or −1E), waveform 36 is reverse in positive and negative to motor current 35 of the U phase.

The neutral point current does not flow (0) when both of switching legs 8a and 8b are off (0) or both of switching legs 8a and 8b are on (+1E or −1E).

The difference between the voltage of capacitor 5a and the voltage of capacitor 5b in the DC bus circuit decreases while neutral point current 36 is positive, and increases while the neutral point current is negative. By way of example, FIG. 9 (D) shows voltage difference V_{diff} (a waveform 38).

As a result of distribution processing by pulse distributor 14, increase in voltage difference between two capacitors 5a and 5b is suppressed. When relation between frequency command Fc and a frequency of a carrier signal is such that the frequency command is in synchronization with the carrier signal in a cycle which is an odd multiple of the carrier and an even multiple of the frequency command, a state where there are an odd number of pulses in two stages may continue, relation in magnitude between the time period of on of the pulses on the positive electrode side and the time period of on of the pulses on the negative electrode side may be fixed, and asymmetry between the positive and the negative may continue.

When switching legs 8a and 8b are alternately turned on, the time period of on the positive side of one of them is longer, the time period of on the negative electrode side of the other is longer, and a state in which one of a discharging time period and a charging time period of capacitor 5b is always slightly longer continues, which may quickly increase the voltage difference between two capacitors 5a and 5b.

When the absolute value of voltage difference V_{diff} between two capacitors exceeds an allowable threshold value Vₜₕ and an orientation of the neutral point current is a direction to further increase the voltage difference in next switching, in order to suppress such increase, switching of switching leg 8a and switching leg 8b is interchanged to change the orientation of the neutral point current to a direction to decrease the capacitor voltage difference so as to suppress increase in voltage difference.

Specifically, when it can be expected that capacitor voltage difference V_{diff} becomes smaller than a threshold value −Vₜₕ as seen at a point 39a and the neutral point current will flow in a direction to further increase capacitor voltage difference V_{diff} like a waveform 39b in next switching (switching leg 8a off and switching leg 8b positive electrode on), adjustment is made such that the negative electrode of switching leg 8a is turned on instead while switching leg 8b remains off to reverse the orientation of the neutral point current and the absolute value of capacitor voltage difference V_{diff} is accommodated within a range of the threshold value as seen in a waveform 39c.

FIG. 9 (B) shows gate pulses GAA # and GBB # obtained by further adjustment of gate pulses GA # and GB #.

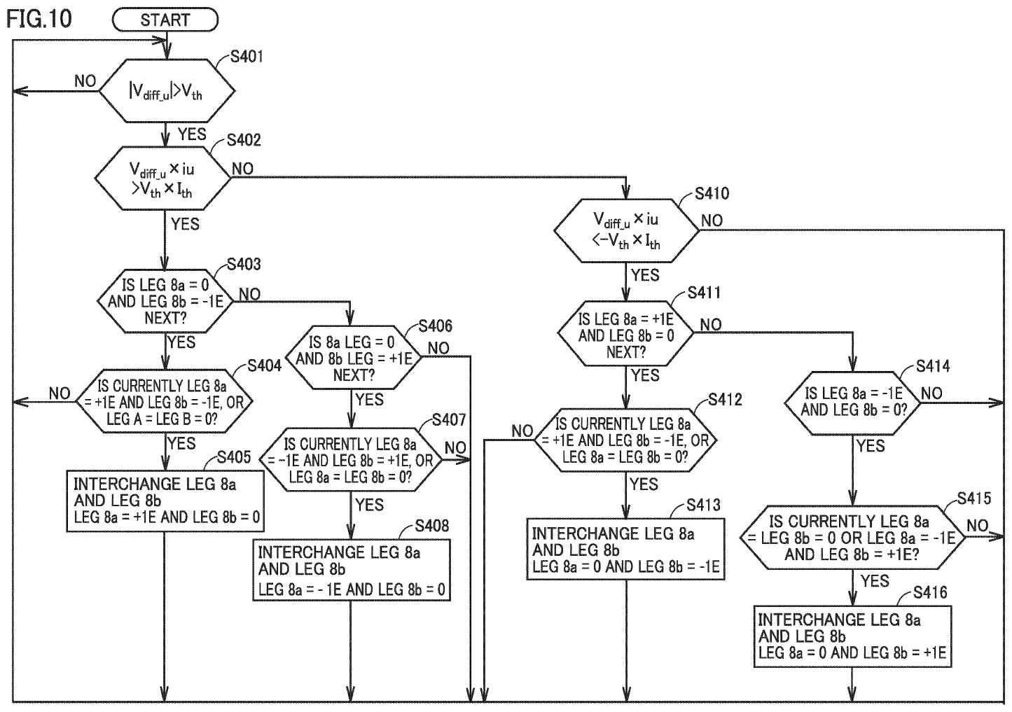

FIG. 10 is a flowchart illustrating the operation of neutral point potential switching control unit 15 according to the second embodiment.

Referring to FIG. 10, a flow of processing in a neutral point potential switching control unit will be described below in line with the figure.

Initially, whether or not the absolute value of a difference |V_{diff_u}| between the voltage of the positive electrode side capacitor and the voltage of the negative electrode side capacitor in a U-phase DC bus circuit has exceeded allowable threshold value Vt is determined (step S401).

In step S401, when the absolute value of difference |V_{diff_u}| between the voltage of the positive electrode side capacitor and the voltage of the negative electrode side capacitor has not exceeded allowable threshold value Vₜₕ (NO in step S401), a state in step S401 is maintained. When the absolute value of difference |V_{diff_u}| between the voltage of the positive electrode side capacitor and the voltage of the negative electrode side capacitor has exceeded allowable threshold value Vₜₕ (YES in step S401), whether or not a product of capacitor voltage difference V_{diff_u} and phase current iu is larger than a product of allowable threshold value Vₜₕ (Vₜₕ>0) of the capacitor voltage difference and a phase current threshold value Iₜₕ (Iₜₕ>0) is checked (step S402).

Determination in step S402 that the product of capacitor voltage difference V_{diff_u} and phase current iu is larger than the product of allowable threshold value Vₜₕ (Vₜₕ>0) of the capacitor voltage difference and phase current threshold value Iₜₕ (Iₜₕ>0) (YES in step S402) means that positive and negative signs of capacitor voltage difference V_{diff_u} and phase current iu are the same.

As described with reference to FIG. 9 (C) which shows waveforms 26a and 26b of the gate pulse signals that cause the neutral point current to flow, phase current iu (waveform 35), and neutral point current Ic (waveform 36), when neutral point current Ic (waveform 36) is on the negative side, capacitor voltage difference V_{diff} increases. When neutral point current Ic (waveform 36) is on the positive side, capacitor voltage difference V_{diff} decreases.

An expression (4) shows relation between capacitor voltage difference V_{diff} and neutral point current Ic.

$$\begin{matrix}[ Expression 4 ] & \\ {V}_{diff} = {V}_{PC} - {V}_{CN} = \frac{Ic}{C 1 s} & ( 4 )\end{matrix}$$

In the expression, C1 represents a capacity of capacitors 5a and 5b. As shown in the expression, since relation of the positive and negative signs of capacitor voltage difference V_{diff} and a neutral point current integrated value are reverse to each other, the product of capacitor voltage difference V_{diff} and phase current iu being positive means that the signs of the neutral point current integrated value and phase current iu are reverse to each other.

In switching where the absolute value of capacitor voltage difference V_{diff} further increases, switching leg 8a (which is also referred to as a leg 8a) provides 0 (a C potential) and switching leg 8b (which is also referred to as a leg 8b) provides a +1E or −1E output.

Therefore, following step S402, whether or not next outputs from legs 8a and 8b are leg 8a=0 and leg 8b=−1E and inverter 4 provides the +1E output are determined (step S403).

When it is determined in step S403 that next outputs from legs 8a and 8b are leg 8a=0 and leg 8b=−1E and inverter 4 provides the +1E output (YES in step S403), the absolute value of capacitor voltage difference V_{diff} exceeds threshold value Vₜₕ and will further increase. Therefore, this switching should be interchanged. In switching after interchange, leg 8a=+1E and leg 8b=0. As described above, in change of outputs from leg 8a and leg 8b, when only one of the positive electrode side and negative electrode side switching elements of switching legs 8a and 8b is switched (turned on or off), a condition for combination of current outputs from the switching legs that can be interchanged is naturally limited.

Combination of current outputs from legs 8a and 8b in which next switching outputs can be leg 8a=0 and leg 8b=−1E before interchange or leg 8a=+1E and leg 8b=0 after interchange includes two types of combination which are combination of leg 8a=+1E and leg 8b=−1E which leads to a combination where an inverter output is +2E and leg 8a=leg 8b=0 which leads to a combination where output is 0.

In step S404, whether combination of current outputs from leg 8a and leg 8b is the combination of leg 8a=+1E and leg 8b=−1E or leg 8a=leg 8b=0 which leads to the combination where output is 0 is determined (step S404).

When it is determined in step S404 that combination of current outputs from leg 8a and leg 8b is the combination of leg 8a=+1E and leg 8b=−1E or leg 8a=leg 8b=0 which leads to the combination where output is 0 (YES in step S404), switching is interchanged between leg 8a and leg 8b. In other words, setting of leg 8a=+1E and leg 8b=0 is made, rather than setting of leg 8a=0 and leg 8b=−1E. Specifically, when the inverter output is +2E (leg 8a=+1E and leg 8b=−1E), switching element 34 on the negative electrode side of leg 8b can be switched to on→off to realize a state of output combination obtained by interchange of switching of leg 8a and leg 8b. When the inverter output is 0 (leg 8a=leg 8b=0), switching element 31 on the positive electrode side of leg 8a can be switched to off→on to realize the state of output combination obtained by interchange of switching of leg 8a and leg 8b.

When it is determined in step S404, on the other hand, that combination of current outputs from leg 8a and leg 8b is not the combination of leg 8a=+1E and leg 8b=−1E or leg 8a=leg 8b=0 which leads to the combination where output is 0 (NO in step S404), the process returns to step S401.

When it is determined in step S403, on the other hand, that next outputs from legs 8a and 8b are not leg 8a=0 and leg 8b=−1E and inverter 4 does not provide the +1E output (NO in step S403), whether or not leg 8a=0 and leg 8b=+1E and the inverter output is the −1E output is determined (step S406).

When it is determined in step S406 that next outputs from legs 8a and 8b are leg 8a=0 and leg 8b=+1E and inverter 4 provides the −1E output (YES in step S406), the absolute value of capacitor voltage difference V_{diff} exceeds threshold value Vₜₕ and will further increase. Therefore, this switching should be interchanged. In switching after interchange, leg 8a=−1E and leg 8b=0. As described above, in change of outputs from leg 8a and leg 8b, when only one of the positive electrode side and negative electrode side switching elements of switching legs 8a and 8b is switched (turned on or off), the condition for combination of current outputs from the switching legs that can be interchanged is naturally limited.

Combination of current outputs from legs 8a and 8b in which next switching outputs can be leg 8a=0 and leg 8b=+1E before interchange or leg 8a=−1E and leg 8b=0 after interchange includes two types of combination which are combination of leg 8a=−1E and leg 8b=+1E which leads to a combination where the inverter output is −2E and leg 8a=leg 8b=0 which leads to the combination where output is 0.

In step S407, whether combination of current outputs from leg 8a and leg 8b is the combination of leg 8a=−1E and leg 8b=+1E or leg 8a=leg 8b=0 which leads to the combination where output is 0 is determined (step S407).

When it is determined in step S407 that combination of current outputs from leg 8a and leg 8b is the combination of leg 8a=−1E and leg 8b=+1E or leg 8a=leg 8b=0 which leads to the combination where output is 0 (YES in step S407), switching is interchanged between leg 8a and leg 8b. In other words, setting of leg 8a=−1E and leg 8b=0 is made, rather than setting of leg 8a=0 and leg 8b=+1E. Specifically, when the inverter output is −2E (leg 8a=−1E and leg 8b=+1E), switching element 33 on the positive side of leg 8b can be switched to on→off to realize the state of output combination obtained by interchange of switching of leg 8a and leg 8b. When the inverter output is 0 (leg 8a=leg 8b=0), switching element 32 on the negative electrode side of leg 8a can be switched to off→on to realize the state of output combination obtained by interchange of switching of leg 8a and leg 8b.

When it is determined in step S406, on the other hand, that next outputs from legs 8a and 8b are not leg 8a=0 and leg 8b=+1E and inverter 4 does not provide the −1E output (NO in step S406), the process returns to step S401. When it is determined in step S407 that combination of current outputs from leg 8a and leg 8b is not the combination of leg 8a=−1E and leg 8b=+1E or leg 8a=leg 8b=0 which leads to the combination where output is 0 (NO in step S407), the process returns to step S401.

In switching control according to the second embodiment, for the purpose of decrease in imbalance in difference between two capacitor voltages in the DC bus circuit, decrease in switching loss of inverter 4, and elimination of imbalance in element loss by pulse distributor 14, only any one of P (positive electrode) side elements 31 and 33 and N (negative electrode) side elements 32 and 34 in two switching legs 8a and 8b is always controlled to be turned on or off.

When it is determined in step S402, on the other hand, that the product of capacitor voltage difference V_{diff_u} and phase current iu is smaller than the product of allowable threshold value Vₜₕ (Vₜₕ>0) of the capacitor voltage difference and phase current threshold value Iₜₕ (Iₜₕ>0) (NO in step S402), whether or not the product of capacitor voltage difference V_{diff_u} and phase current iu is smaller than −1 time as large as the product of allowable threshold value Vₜₕ (Vₜₕ>0) of the capacitor voltage difference and phase current threshold value Iₜₕ (Iₜₕ>0) is then determined (step S410).

When it is determined in step S410 that the product of capacitor voltage difference V_{diff_u} and phase current iu is smaller than −1 time as large as the product of allowable threshold value Vₜₕ (Vₜₕ>0) of the capacitor voltage difference and phase current threshold value Iₜₕ (Iₜₕ>0) (YES in step S410), the positive and negative signs of the capacitor voltage difference and the phase current are different because the sign of the product is negative.

Therefore, in consideration of the expression (4), the positive and negative signs of the neutral point current integrated value and the phase current are the same.

In switching where the absolute value of capacitor voltage difference V_{diff} further increases, switching leg 8a provides +1E or −1E and switching leg 8b provides 0.

Therefore, following step S410, whether or not next outputs from legs 8a and 8b are leg 8a=+1E and leg 8b=0 and inverter 4 provides the +1E output is determined (step S411).

When it is determined in step S411 that next outputs from legs 8a and 8b are leg 8a=+1E and leg 8b=0 and inverter 4 provides the +1E output (YES in step S411), the absolute value of capacitor voltage difference V_{diff} exceeds threshold value Vₜₕ and will further increase. Therefore, this switching should be interchanged. In switching after interchange, leg 8a=0 and leg 8b=−1E. As described above, in change of outputs from leg 8a and leg 8b, when only one of the positive electrode side and negative electrode side switching elements of switching legs 8a and 8b is switched (turned on or off), the condition for combination of current outputs from the switching legs that can be interchanged is naturally limited.

Combination of current outputs from legs 8a and 8b in which next switching outputs can be leg 8a=+1E and leg 8b=0 before interchange or leg 8a=0 and leg 8b=−1E after interchange includes two types of combination which are combination of leg 8a=+1E and leg 8b=−1E which leads to the combination where the inverter output is +2E and leg 8a=leg 8b=0 which leads to the combination where output is 0.

In step S412, whether combination of current outputs from leg 8a and leg 8b is the combination of leg 8a=+1E and leg 8b=−1E or leg 8a=leg 8b=0 which leads to the combination where output is 0 is determined (step S412).

When it is determined in step S412 that combination of current outputs from leg 8a and leg 8b is the combination of leg 8a=+1E and leg 8b=−1E or leg 8a=leg 8b=0 which leads to the combination where output is 0 (YES in step S412), switching is interchanged between leg 8a and leg 8b. In other words, setting of leg 8a=0 and leg 8b=−1E is made, rather than setting of leg 8a=+1E and leg 8b=0. Specifically, when the inverter output is +2E (leg 8a=+1E and leg 8b=−1E), switching element 31 on the positive electrode side of leg 8a can be switched to on→off to realize the state of output combination obtained by interchange of switching of leg 8a and leg 8b. When the inverter output is 0 (leg 8a=leg 8b=0), switching element 34 on the positive electrode side of leg 8b can be switched to off→on to realize the state of output combination obtained by interchange of switching of leg 8a and leg 8b.

When it is determined in step S412, on the other hand, that combination of current outputs from leg 8a and leg 8b is not the combination of leg 8a=+1E and leg 8b=−1E or leg 8a=leg 8b=0 which leads to the combination where output is 0 (NO in step S412), the process returns to step S401.

When it is determined in step S411, on the other hand, that next outputs from legs 8a and 8b are not leg 8a=+1E and leg 8b=0 and inverter 4 does not provide the +1E output (NO in step S411), whether or not leg 8a=−1E and leg 8b=0 and the inverter output is the −1E output is determined (step S414).

When it is determined in step S414 that next outputs from legs 8a and 8b are leg 8a=−1E and leg 8b=0 and inverter 4 provides the −1E output (YES in step S414), the absolute value of capacitor voltage difference V_{diff} exceeds threshold value Vₜₕ and will further increase. Therefore, this switching should be interchanged. In switching after interchange, leg 8a=0 and leg 8b=+1E. As described above, in change of outputs from leg 8a and leg 8b, when only one of the positive electrode side and negative electrode side switching elements of switching legs 8a and 8b is switched (turned on or off), the condition for combination of current outputs from the switching legs that can be interchanged is naturally limited.

Combination of current outputs from legs 8a and 8b in which next switching outputs can be leg 8a=−1E and leg 8b=0 before interchange or leg 8a=0 and leg 8b=+1E after interchange includes two types of combination which are combination of leg 8a=−1E and leg 8b=+1E which leads to the combination where the inverter output is −2E and leg 8a=leg 8b=0 which leads to the combination where output is 0.

In step S415, whether combination of current outputs from leg 8a and leg 8b is combination of leg 8a=−1E and leg 8b=+1E or leg 8a=leg 8b=0 which leads to the combination where output is 0 is determined (step S415).

When it is determined in step S415 that combination of current outputs from leg 8a and leg 8b is the combination of leg 8a=−1E and leg 8b=+1E or leg 8a=leg 8b=0 which leads to the combination where output is 0 (YES in step S415), switching is interchanged between leg 8a and leg 8b. In other words, setting of leg 8a=0 and leg 8b=+1E is made, rather than setting of leg 8a=−1E and leg 8b=0. Specifically, when the inverter output is −2E (leg 8a=−1E and leg 8b=+1E), switching element 32 on the negative electrode side of leg 8a can be switched to on→off to realize the state of output combination obtained by interchange of switching of leg 8a and leg 8b. When the inverter output is 0 (leg 8a=leg 8b=0), switching element 33 on the positive electrode side of leg 8b can be switched to off→on to realize the state of output combination obtained by interchange of switching of leg 8a and leg 8b.

When it is determined in step S414, on the other hand, that next outputs from legs 8a and 8b are not leg 8a=−1E and leg 8b=0 and inverter 4 does not provide the −1E output (NO in step S414), the process returns to step S401. When it is determined in step S415 that combination of current outputs from leg 8a and leg 8b is not combination of leg 8a=−1E and leg 8b=+1E or leg 8a=leg 8b=0 which leads to the combination where output is 0 (NO in step S415), the process returns to step S401.

Neutral point potential switching control unit 15 performs processing above not only to decrease imbalance in switching by the switching elements with switching by each element being minimized but also to suppress sudden increase in voltage difference between two capacitors 5a and 5b in the DC bus circuit due to influence by the load and the power factor by switching under a prescribed frequency condition but also to suppress generation of overvoltage of the capacitor voltage and increase in torque ripple due to asymmetry between the positive output voltage and the negative output voltage and resultant unstable control.

The present disclosure is susceptible to free combination of a part or the entirety of each embodiment or modification or omission of each embodiment as appropriate, within the scope of the disclosure.

The configurations exemplified as the embodiments described above are exemplary configurations of the present disclosure, and can be combined with another known technique or can be configured as being modified, for example, partially omitted, without departing from the gist of the present disclosure. In the embodiments described above, processing and a configuration described in another embodiment may be adopted and performed as appropriate.

It should be understood that the embodiments disclosed herein are illustrative and non-restrictive in every respect. The scope of the present disclosure is defined by the terms of the claims rather than the description above and is intended to include any modifications within the scope and meaning equivalent to the terms of the claims.

### REFERENCE SIGNS LIST

2 power conversion device; 3 motor; 4 inverter; 5a positive electrode side capacitor; 5b negative electrode side capacitor; 6, 31, 32, 33, 34 switching element; 7 clamp diode; 8a, 8b switching leg; 10 control unit; 11 modulation factor computing unit; 12 carrier comparison PWM generator; 13 gate signal allocator; 14 pulse distributor; 15 neutral point potential switching control unit; 18 current sensor; 19 V/f controller; 20a, 20b, 20c neutral point voltage sensor.

1. A power conversion device comprising:
an inverter including a plurality of switching elements, the inverter receiving input of a DC voltage from a DC voltage source and converting the DC voltage into a variable voltage variable frequency AC voltage to output the AC voltage to a load;
a control circuit that controls on/off drive of the plurality of switching elements under PWM control; and
a series body of a positive electrode side capacitor and a negative electrode side capacitor connected between a positive electrode and a negative electrode of the DC voltage source on an input side of the inverter, wherein
an output potential of the inverter at least has a potential of the positive electrode and a potential of the negative electrode of the DC voltage source and a potential of a neutral point which is a point of connection between the positive electrode side capacitor and the negative electrode side capacitor, and
the control circuit includes
a modulation factor computing circuit that computes a modulation factor of the inverter based on the DC voltage and an output voltage command value,
a gate signal generator circuit that generates a gate signal necessary for on/off drive of the switching elements for generation of a pulse train based on comparison between the computed modulation factor and a carrier signal, and
a gate signal allocator circuit that adjusts allocation of the gate signal such that a voltage of the positive electrode side capacitor and a voltage of the negative electrode side capacitor are balanced.

2. The power conversion device according to claim 1, wherein
the inverter includes a plurality of switching circuits, and
the gate signal allocator circuit further includes a pulse distributor that sequentially allocates the gate signal necessary for on/off drive of switching elements in the plurality of switching circuits and allocates pulse generation to the plurality of switching circuits.

3. The power conversion device according to claim 2, wherein
the pulse distributor allocates an order such that the plurality of switching circuits are alternately turned on, in connection with the gate signal necessary for on/off drive of the switching elements in the plurality of switching circuits.

4. The power conversion device according to claim 2, wherein
the gate signal allocator circuit further includes a neutral point potential switching control unit that determines, when an absolute value of a difference between the voltage of the positive electrode side capacitor and the voltage of the negative electrode side capacitor exceeds a threshold value, whether the difference will further increase, based on allocation of the gate signal, and changes allocation of the gate signal to the switching elements in the plurality of switching circuits such that the difference will decrease when the gate signal allocator circuit determines that the difference will increase.

5. The power conversion device according to claim 3, wherein
the gate signal allocator circuit further includes a neutral point potential switching control unit that determines, when an absolute value of a difference between the voltage of the positive electrode side capacitor and the voltage of the negative electrode side capacitor exceeds a threshold value, whether the difference will further increase, based on allocation of the gate signal, and changes allocation of the gate signal to the switching elements in the plurality of switching circuits such that the difference will decrease when the gate signal allocator circuit determines that the difference will increase.
